(19) United States
(12) Patent Application Publication
(10) Pub. No.: US 2026/0256153 A1
(43) Pub. Date: Sep. 3, 2026

(54) DEHIDER BLADES AND A HANDHELD DEHIDER USING THE SAME

(71) Applicant: Jarvis Products Corporation, Middletown, CT (US)

(72) Inventors: Mike Abdul, Middletown, CT (US); Dave Thrall, Middletown, CT (US)

(21) Appl. No.: 19/552,579

(22) Filed: Feb. 27, 2026

Related U.S. Application Data
(60) Provisional application No. 63/765,993, filed on Mar. 3, 2025.

(51) Int. Cl. A22B 5/16; B26B 25/00

(52) U.S. Cl. CPC A22B 5/168; A22B 5/163; B26B 25/002

(57) ABSTRACT

A handheld dehider with cutting discs or blades to remove the hide of a carcass and/or cut the carcass in a meat processing facility. Cutting discs of the handheld dehider are designed to form minute circular (micro) segments and grooves extending radially outwards in a ring pattern to reduce grinding, filing, and vibrations against the handheld dehider blade housing. The cutting discs abut portions of the blade housing cover, and in doing so, during the break-in period, circularly projecting segments on the outwardly exposed face of each cutting disc have less surface area exposed to the contact surface at the cutting disc/blade housing cover interface than radially projecting segments.

### BACKGROUND OF THE INVENTION

### 1. Field of the Invention

The present invention relates to the field of food industry, and specifically a handheld dehider utilizing rotary blades or cutting discs for cutting carcasses and/or food products, mainly meat products. More specifically, the present invention relates to a handheld dehider with cutting discs or blades to remove the hide of a carcass and/or cut the carcass in a meat processing facility. The present invention further relates to the cutting discs of the handheld dehider, which are designed to form minute circular segments to reduce grinding and filing against a handheld dehider blade housing.

### 2. Description of Related Art

Motorized rotary blades are widely used in meat processing facilities for meat cutting and trimming operations. For example, handheld dehiders are used in meat processing facilities chiefly to remove the hide from an animal carcass. The most common type of dehider includes a pair of adjacent cutting discs or blades that are driven in opposed cutting oscillations by a corresponding pair of pushrods. A basic design is shown in U.S. Pat. No. 5,122,092 and U.S. Patent No. 8,047,901, both assigned to Jarvis Products Corporation, the applicant and assignee of the present invention.

Motorized rotating blades typically include a handle assembly and a head assembly attachable to the handle assembly. The head assembly includes an annular cutting disc or blade housing and annular rotating cutting discs or blades supported for rotation by the cutting disc housing. The rotating cutting disc of conventional motorized rotary designs is typically rotated by a drive assembly that includes a flexible shaft drive assembly that extends through an opening in the handle assembly. The shaft drive assembly engages and rotates a pinion gear supported by the head assembly. The flexible shaft drive assembly includes a stationary outer sleeve and a rotating inner drive shaft that is driven by an air or electric motor.

In a dehider design, each cutting disc or blade includes teeth around its perimeter. Adjacent discs or blades are driven in opposed cutting oscillations by a pair of pushrods connected to an eccentric drive mechanism typically operated by a pneumatic motor mounted in the handle of the tool. The rotating blade generally includes a driven gear comprising a plurality of gear teeth or a set of gear teeth extending radially between and through an inner wall.

Typically, a motor rotates a pinion gear, which turns a main drive gear, which may be oriented at ninety degrees to the axis of the motor. The main drive gear turns an eccentric shaft to oscillate pushrods. During each oscillation, the teeth on one cutting disc move past the teeth on the adjacent and oppositely moving cutting disc. This produces a shearing and cutting action that quickly removes the hide from the carcass.

A problem of current designs involves the manufacturing of the cutting disc or blade. The manufacturing process inherently results in swirl marks that emanate radially from the center of the bore of the cutting disc. Often, the teeth are chamfered with the same swirl marks. Generally, a blade housing encompasses the cutting discs, where each cutting disc is located centrally and secured or clamped into position. Under normal cutting disc manufacturing conditions, the swirling pattern is formed and extends radially outwards from the cutting disc center, initiating fine, raised, minute segments and adjacent grooves ("micro-segments" and "micro-grooves"). For the purposes of this description, the terms micro-segments and micro-grooves identifies these blade features as being very small, fine lines raised above the blade surface, and separated from one another by minuscule spaces or grooves. The adjective "micro" need not restrict the height or width of the segments, nor the depth or width of the grooves, to a micron (1 x 10⁻⁶ m) dimension, although such a dimension may be accurate. These swirling micro-segments emanate radially outwards, and extend to the cutting disc teeth.

A handheld dehider incorporating this type of cutting disc includes an inward facing support housing surface that abuts the blade circular body on each side, contacting each cutting disc outwardly exposed face. Upon rotation, the radially swirling micro-segments act as a file against the abutting housing surfaces. This causes a grinding action that files down and removes a portion of the housing surface until the radial micro-grooves are either filled, forming a flat surface, or the micro-segments are worn down, or both. Alternatively, the housing surface grinds down to receive the radial micro-segments of the blade circular body.

It is during this "break-in" period of initial operation that causes the unwanted filing of the housing portion abutting the cutting disc body, and possibly micro-component discharge onto the cutting surface. This filing and grinding action also manifests adverse vibration during start-up.

### SUMMARY OF THE INVENTION

Bearing in mind the problems and deficiencies of the prior art, it is therefore an object of the present invention to provide a cutting disc or blade for a handheld dehider that minimizes any filing or grinding action against the blade housing.

It is another object of the present invention to provide a set of cutting discs or blades that facilitate the break-in period for a dehider.

It is yet another object of the present invention to provide a handheld dehider for removing the hide of a carcass in a meat processing facility that utilizes a set of cutting discs or blades having circularly formed micro-segments that reduce grinding, filing, and the fabrication of extraneous debris, especially during the handheld dehider break-in period.

Still other objects and advantages of the invention will in part be obvious and will in part be apparent from the specification.

The above and other objects, which will be apparent to those skilled in the art, are achieved in the present invention which is directed to a handheld dehider for removing the hide of a carcass in a meat processing facility comprising: a housing having a drive mechanism cover and a blade housing cover; a drive mechanism in the housing including: an eccentric shaft, and a pair of pushrods connected to the eccentric shaft; a motor in the housing connected to turn the eccentric shaft and oscillate the pair of pushrods; a cutting disc shaft; and a pair of removably attachable cutting discs mounted for oscillating rotary motion on the cutting disc shaft, each cutting disc including micro-segments separated by micro-grooves extending in a ring pattern radially outwards from a center of a bore of the cutting disc to an outer radial edge of the cutting disc, adjacent a cutting disc rim, where cutting disc teeth extend substantially radially outwards.

The micro-segments and micro-grooves may be approximately perpendicular to a radial line extending from the center of the bore of the cutting disc.

The handheld dehider includes a drive mechanism mounted in the housing and configured to be operated by the motor for driving at least one of the cutting discs.

The pair of cutting discs are mounted on the cutting disc shaft in reversed orientations.

In a second aspect, the present invention is directed to a cutting disc for a handheld dehider, removing the hide of a carcass in a meat processing facility, the cutting disc having a center located within a bore of the cutting disc, and an exposed front planar face, the exposed front planar face comprising circular machined micro-segments separated by micro-grooves and forming a ring pattern, wherein rings of micro-segments extend radially outwards from the bore of the cutting disc.

The circular machined micro-segments may extend to an outer radial edge of the cutting disc, adjacent a cutting disc rim, where cutting disc teeth extend radially outwards, and may extend beyond a gullet portion of the cutting disc teeth.

The cutting disc teeth may include radially projecting micro-segments beyond a gullet portion of the cutting disc teeth, the radially projecting micro-segments approximately perpendicular to the circularly machined micro-segments in a ring pattern on the cutting disc exposed front face, the ring pattern extending radially outwards from the cutting disc center.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description that follows taken in conjunction with the accompanying drawings in which:

FIG. 1 is a dehider tool designed to utilize the cutting discs or blades of the present invention;

FIG. 2 is a right-side elevational view of the dehider of FIG. 1, taken in cross section along the line 2-2 in FIG. 1;

FIG. 3 is a side elevational view in cross section of the blade hub portion of the handheld dehider as seen in FIGS. 1 and 2;

FIG. 4 depicts a partial, perspective view of a handheld dehider designed to utilize cutting discs of the present invention;

FIG. 5 depicts a cutting disc of the prior art, illustrating some of the radially projecting micro-segments inherently formed during manufacturing, and extending from the center of the bore of the cutting discs to an outer radial edge adjacent the cutting disc rim where the teeth are formed; and

FIG. 6 depicts cutting discs with purposely manufactured, circularly machined micro-segments / micro-grooves of the present invention.

### DESCRIPTION OF THE PREFERRED EMBODIMENTS

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the singular forms "a", "an" and "the" are intended to include the plural forms as well, unless the context clearly indicates otherwise. Also, as used herein, the term "and/or" includes any and all combinations of one or more of the associated listed items. It will be further understood that the terms "include" and/or "including" when used herein, specify the presence of stated features, steps, operations, elements, and/or components, but do not preclude the presence or addition of one or more other features, steps, operations, elements, components, and/or groups thereof.

Relative terms such as "below," "above," "upper," "lower," "horizontal," "vertical," "top," "bottom," "rear," "front," "side," or the like may be used herein to describe a relationship of one element or component to another element or component as illustrated in the figures. It will be understood that these terms are intended to encompass different orientations of the device in addition to the orientation depicted in the figures.

Additionally, in the subject description, the words "exemplary," "illustrative," or the like are used to mean serving as an example, instance or illustration. Any aspect or design described herein as "exemplary" or "illustrative" is not necessarily intended to be construed as preferred or advantageous over other aspects or design. Rather, use of the words "exemplary" or "illustrative" is merely intended to present concepts in a concrete fashion.

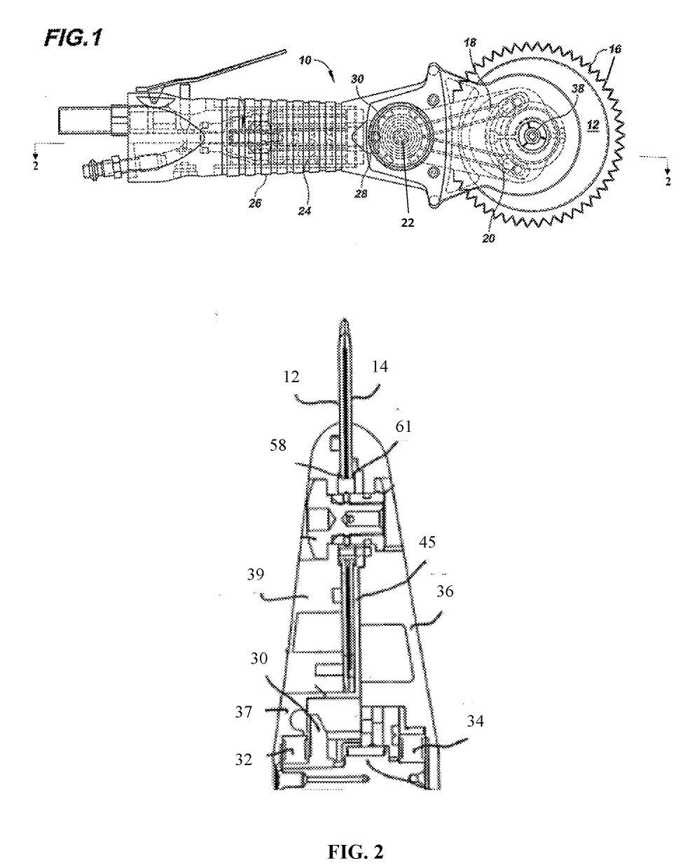

In describing the embodiment of the present invention, reference will be made herein to FIGS. 1 – 6 of the drawings in which like numerals refer to like features of the invention.

A typical dehider tool that may utilize the cutting disc or blades of the present invention is depicted in FIG. 1.

FIGS. 1 and 2 show a handheld dehider 10 capable of supporting the cutting discs of the present invention. The handheld dehider 10 includes a pair of adjacent, removably attachable cutting discs or blades 12 and 14 (the blade tips of which can be seen adjacent to and behind cutting disc 12), both having teeth 16 located around the perimeter of each cutting disc. The cutting discs 12, 14 are driven by a pair of pushrods 18, 20 such that, upon activation, opposed cutting oscillations are generated by an eccentric shaft.

The pair of cutting discs are mounted for an oscillating rotary motion on the cutting disc shaft, the cutting discs being driven by pushrods in opposed cutting oscillations. Each cutting disc having a central opening or bore with a center, and may include a bearing lip surrounding the central opening, the central opening and bearing lip forming a bearing surrounding the cutting disc shaft.

FIG. 1 is a top plan view of a handheld dehider 10. FIG. 2 is a right-side elevational view of the first embodiment of the dehider 10, taken in cross section along the line 2-2 in FIG. 1.

The eccentric shaft 22 is driven by pneumatic motor 24 located in the handle 26 of the tool housing. The motor 24 drives pinion gear 28, which engages and turns the main drive gear 30. The main drive gear 30 is mounted on the eccentric shaft such that rotation of the motor and pinion gear turns the main drive gear and eccentric shaft to drive the pushrods and cutting discs.

The eccentric shaft 22 is held between a pair of bearings 32, 34 mounted in the housing 36 of the dehider (see FIG. 2). The housing includes the handle 26 at the back of the tool, and a forward end of the tool that wraps around and below the drive area and extends underneath the cutting discs. The housing also includes a drive mechanism cover 37 that extends over the drive area and below the cutting discs, and a blade cover 39 located at the forward end of the cutting discs.

The cutting discs 12, 14 are located on one side of a barrier plate 45, in contact with a flat portion thereof. The barrier plate 45 serves not only as a barrier against the entry of contaminating material, but also as a flat bearing surface against which the cutting discs 12, 14 slide. This large flat bearing surface stabilizes the cutting discs and prevents them from twisting during use. In order to minimize wear, the barrier plate is preferably made of a harder material than the remainder of the housing.

As shown, the dehider tool includes a housing having a shape that can be gripped comfortably by a human hand. The pair of adjacent cutting discs 12, 14 that are arranged parallel to one other, protrude out of a distal end of the housing.

The cutting discs or blades 12, 14 generally have teeth having a shape of a regular convex polygon. A regular convex polygon is a polygon that is equiangular and equilateral and that has sides extending between adjacent outer vertices. Typically, a regular convex polygon, as used in the present application, does not include a star polygon. In the illustrated embodiment, the blades 12, 14 each have the shape of a ten-sided regular convex polygon, also known as a decagon. However, it is contemplated that a cutting disc having fewer or more than ten sides could also be used without detriment to the implementation of the present invention. The preferred embodiment is a blade having teeth shaped as a regular convex polygon having at least five sides.

The cutting discs 12, 14 each have an outward facing side and terminate on their outer edge with sharp teeth that define a continuous cutting edge that extends circumferentially about the outer periphery of each cutting disc 12, 14. The cutting discs 12, 14 outward and inward facing sides are substantially planar. The inward facing planar side is a flat surface adapted to be engaged by a corresponding inward planar side of the other cutting disc. The outward facing sides of the blades 12, 14 are generally beveled to form the sharp edges or teeth around the outer periphery. The cutting discs 12, 14 are substantially identical in size and shape, which reduces parts inventory and minimize vibrations during use.

During each cutting oscillation the teeth 16 on blade 12 pass by the oppositely moving teeth on adjacent cutting disk 14. As the eccentric shaft continues to rotate, the pushrods 18, 20 are drawn back and the direction of motion of the cutting disks 12, 14 is reversed. This causes the cutting teeth 16 on one blade to again pass by the oppositely moving teeth on the other blade to produce a scissors-like action between the oppositely moving teeth that quickly and effectively allows the dehider operator to remove the hide of the carcass.

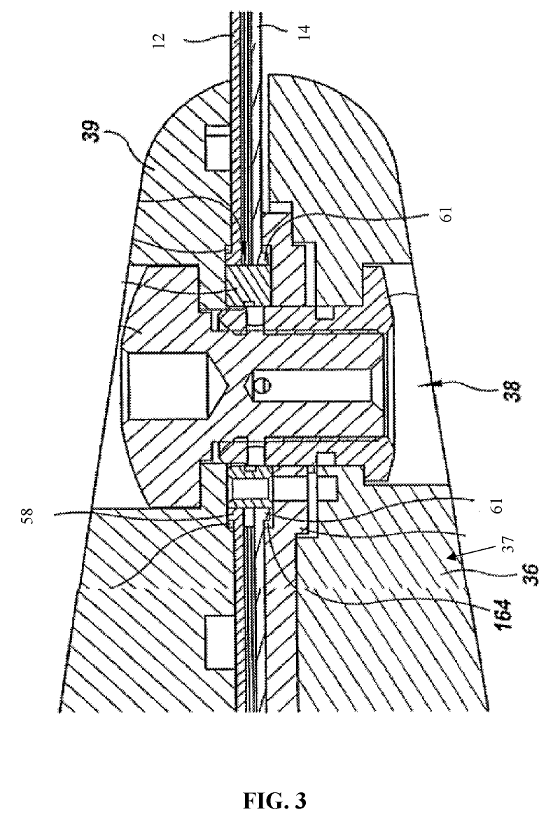

FIG. 3 is a side elevational view in cross section of the blade hub portion of the handheld dehider as seen in FIGS. 1 and 2.

Referring to FIG. 3, cutting discs 12, 14 of this illustrative handheld dehider have a cylindrical bearing lips 58, 61 on cutting disc 12 and 61 on cutting disc 14, that significantly increases the bearing surface between the cutting disks and the outer bearing surface of the collar.

In at least one embodiment, the cutting discs are preferably produced having a portion with material that is thicker than the final thickness of the outer area of the disk, and equal in thickness to the cylindrical bearing lips 58, 61 at the center of the disk. Optimally, the cutting disc or blades are ground to reduce their thickness everywhere except at the cylindrical bearing lips 58 and 61. This provides structural integrity for mounting, and simultaneously allows for the necessary clearance during rotation.

It will be noted that generally the cutting discs 12 and 14 are identical except that one is inverted relative to the other. The bearing lips 58, 61 project outward at ninety degrees to the plane of their respective cutting discs. When the cutting discs are inverted and placed in back-to-back contact with each other, as illustrated, the lips 58 and 61 project in opposite directions and do not interfere with each other.

As noted in FIG. 3, the housing also includes a drive mechanism cover 37 that extends over the drive area and immediately below the cutting discs, and a blade housing cover 39 located above the center of the cutting discs, exposing the blades at the distal end.

Cutting discs 12, 14 abut portions of the blade housing cover 39, and in doing so, during initial operation, the "break-in period", the radially projecting (prior art) micro-segments on the face of each cutting disc and grind or file the contact surface at the cutting disc/blade housing cover interface.

It is understood that all hand-held dehiders of this basic design are subject to an operational vibration resulting from the oscillating mass of the pushrods and blades being driven by the eccentric drive system. During each rotation of the eccentric shaft, the two pushrods are driven forward and back, and the disk blades are accelerated in a first direction, then stopped and accelerated in the opposite direction. In addition to this operational vibration is a "start-up" vibration that is caused by the micro-segments grinding during initial activation against blade cover 39. Prior art designs had introduced food-grade grease to this interface in order to reduce the friction and grinding of the blade cover and the micro-segments. However, the grease blackens the debris and can collect with the other particle debris on the product being cut or sliced.

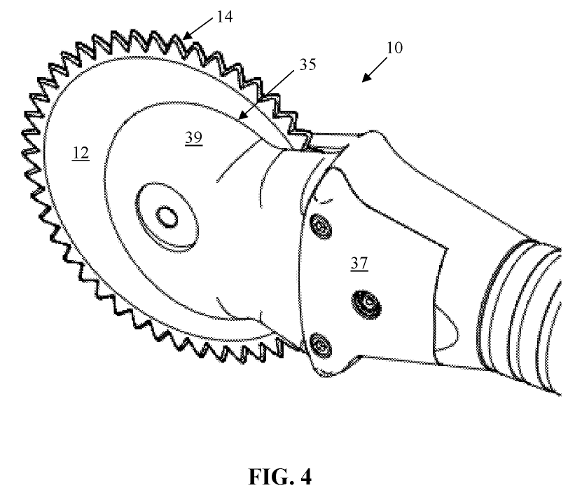

FIG. 4 depicts a partial, perspective view of the handheld dehider 10 utilizing cutting discs 12, 14 of the present invention. At the junction or interface 35 of the blade housing cover 39 and the outward face of the cutting discs 12, 14, the inside surface of blade housing cover 39 will contact the micro-segments of the cutting discs.

During rotation of the cutting discs of the prior art, the top portion of the radially projecting micro-segments on the outward face of each cutting disc will abut almost the entirety of the blade housing cover junction in a rotational, sweeping fashion. This poses multiple problems.

The continuous filing or grinding of the blade housing cover 39 at interface 35 will increase ramp-up time for the operation of the dehider. There is also a resultant blackening effect due to the particles, grease, and debris created by the grinding action of the micro-segments on the blade housing cover interface. The slidable contact motion of this blade/housing interaction requires heavily (food grade) greased surfaces, which becomes darker in color, and may turn black during grinding as a by-product of the grease interacting with the filing debris.

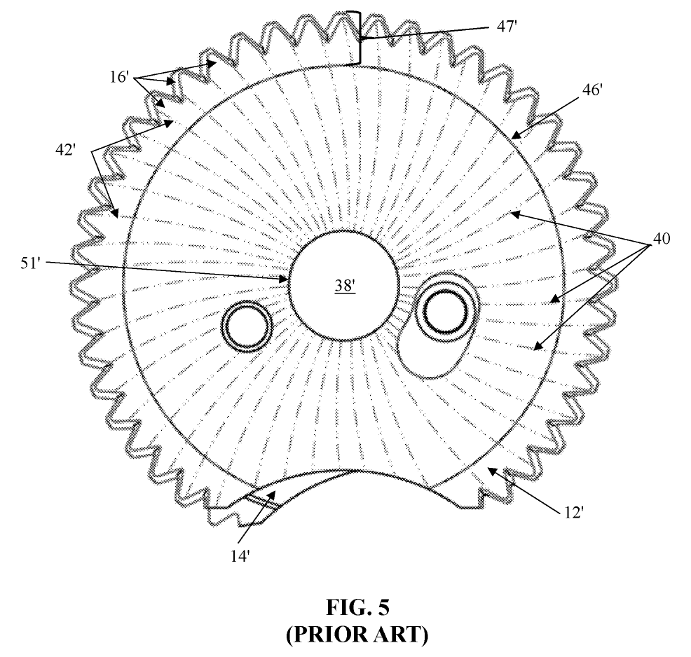

FIG. 5 depicts a cutting disc of the prior art, illustrating some of the radially projecting micro-segments 40, extending from the center 38' of the bore 51' of each cutting disc 12', 14' to an outer radial edge 46' adjacent the cutting disc rim 47' where the teeth 16' are formed. Radial micro-segments 42' typically progress to teeth 16', and may extend to the teeth chamfering portion.

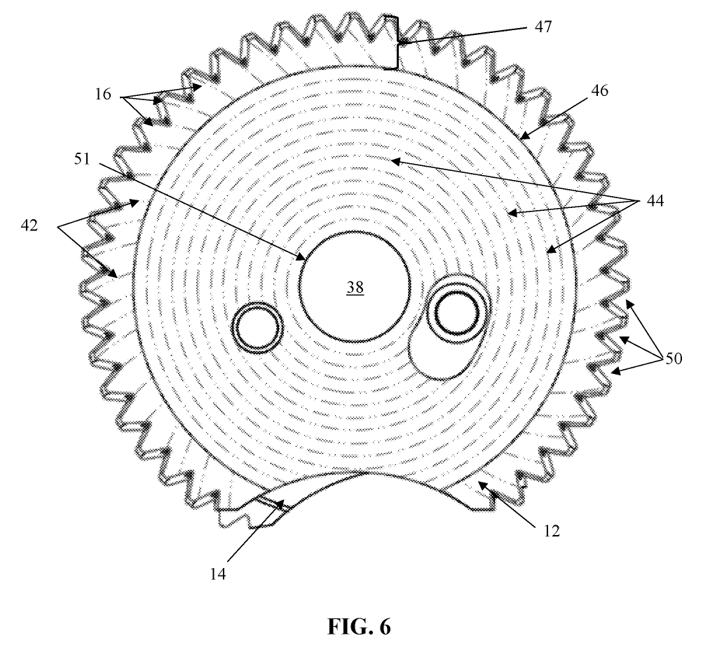

FIG. 6, in contrast to FIG. 5, depicts a preferred embodiment of the cutting discs 12, 14 of the present invention with circularly machined micro-segments 44. The circular micro-segments 44 extend proximate the center 38 of the bore 51 of the cutting disc to the outer radial edge 46, adjacent the cutting disc rim 47, where the teeth 16 are formed. The circular micro-segments are perpendicular to a radial line extending from the center 38. The circular micro-segments for a ring pattern radially outwards in increasing radii, proximate from the bore 51 of the cutting disc. The cutting disc rim 47 may have teeth 16 formed with circularly machined micro-segments, which may extend beyond the gullet portion 50 of the teeth, or as depicted in FIG. 6, may still have radially machined micro-segments 42 in the cutting disc rim 47 portion.

The circularly machined micro-segments 44 on the face of each cutting disc will still carve into the blade housing cover 39 at junction 35; however, the grinding or carving will be significantly limited due to the reduced surface area contact. The top portion of each micro-segment contacts the housing cover perpendicular to a radial line extending from the cutting disc center within the cutting disc bore, and thus significantly less blade/housing surface area is involved during rotation at the initial break-in period. This reduces ramp-up time for the operation of the dehider, extraneous vibrations, as well as a reduction in the blackening effect due to the particles and debris created by the grinding action of the micro-segments of the blades with the blade housing cover interface. The need for heavily greased surfaces is diminished, and the generation of filing debris is greatly reduced.

Utilizing the cutting discs of FIG. 6, a handheld dehider is configured to remove the hide of a carcass in a meat processing facility with very little filing, grinding, or extraneous debris.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A handheld dehider for removing the hide of a carcass in a meat processing facility comprising:
a housing having a drive mechanism cover and a blade housing cover;
a drive mechanism in the housing including:
an eccentric shaft;
a pair of pushrods connected to the eccentric shaft;
a motor in the housing connected to turn the eccentric shaft and oscillate the pair of pushrods;
a cutting disc shaft; and
a pair of removably attachable cutting discs or blades mounted for oscillating rotary motion on said eccentric shaft, each cutting disc or blade including micro-segments separated by micro-grooves extending in a ring pattern radially outwards from a center of a bore of the cutting disc to an outer radial edge of the cutting disc, adjacent a cutting disc rim, and having cutting disc teeth extending substantially radially outwards.

2. The handheld dehider of claim 1 wherein the micro-segments are approximately perpendicular to a radial line extending from the center of the bore of the cutting disc.

3. The handheld dehider of claim 1 including a drive mechanism mounted in the housing and configured to be operated by the motor for driving at least one of the cutting discs.

4. The handheld dehider of claim 1 wherein said pair of cutting discs are mounted on the cutting disc shaft in reversed orientations.

5. A cutting disc for use on a handheld dehider, capable of removing the hide of a carcass in a meat processing facility, said cutting disc having a center located within a bore of the cutting disc, and an exposed front planar face, said exposed front planar face comprising circular machined micro-segments separated by micro-grooves and forming a ring pattern, wherein rings of micro-segments extend radially outwards from the bore of the cutting disc.

6. The cutting disc of claim 5 wherein the circular machined micro-segments extend to an outer radial edge of the cutting disc, adjacent a cutting disc rim, where cutting disc teeth extend radially outwards.

7. The cutting disc of claim 6 wherein the circular machined micro-segments extend beyond a gullet portion of the cutting disc teeth.

8. The cutting disc of claim 6 wherein the cutting disc teeth include radially projecting micro-segments beyond a gullet portion of the cutting disc teeth, the radially projecting micro-segments approximately perpendicular to the circularly machined micro-segments in a ring pattern on the cutting disc exposed front face, the ring pattern extending radially outwards from the cutting disc center.

9. The cutting disc of claim 6 wherein the cutting disc teeth include projecting micro-segments beyond a gullet portion of the cutting disc teeth, the projecting micro-segments approximately parallel to the circularly machined micro-segments in a ring pattern on the cutting disc exposed front face, the ring pattern extending radially outwards from the cutting disc center.

10. The cutting disc of claim 6 wherein said cutting disc teeth extend from said cutting disc rim are shaped as a regular convex polygon having at least five sides.

11. The cutting disc of claim 5 wherein said disc is removably attachable to a handheld dehider.

12. The cutting disc of claim 6 including an outward facing terminating on an outer edge forming said cutting disc teeth defining a continuous cutting edge that extends circumferentially about an outer periphery.

13. The cutting disc of claim 12 including outward and inward facing sides being substantially planar.

14. The cutting disc of claim 13 wherein said inward facing planar side is a flat surface adapted to be engaged by a corresponding inward planar side of a second cutting disc.

15. The cutting disc of claim 13 wherein said outward facing side is beveled to form said cutting disc teeth around an outer periphery.
